(19) United States
(12) Patent Application Publication
(10) Pub. No.: US 2005/0205563 A1
(43) Pub. Date: Sep. 22, 2005

(54) Apparatus for warming a tyre on a wheel to a temperature required for vehicle racing

(76) Inventors: Stuart Hepworth, West Yorkshire (GB); Gordon Andrews, Kent (GB)

Correspondence Address: Iandiorio & Teska, 260 Bear Hill Road, Waltham, MA, 02451-1018, US

(21) Appl. No.: 10/516,831

(22) PCT Filed: Jun. 3, 2003
(86) PCT No.: PCT/GB03/02416

§ 371 Date: Dec. 3, 2004

(30) Foreign Application Priority Data
Jun. 7, 2002 (GB) 0213133.2
Oct. 2, 2002 (GB) 0222839.3

(51) Int. Cl. H05B 6/64

(52) U.S. Cl. 219/679

(57) ABSTRACT

Apparatus (2) for warming a tyre (4) on a wheel (6) to a temperature required for vehicle racing, which apparatus (2) in which the tyre (4) is heated, mounting means (10) which is positioned in the container (8) and on which the wheel (6) is mounted, generator means (16) for generating electromagnetic energy of a frequency that heats the tyre (4), temperature indicator means (18) for indicating the temperature of the tyre (4), and control means for controlling the operation of the apparatus (2) such that the tyre (4) is controllably heated to a temperature required for vehicle racing.

This invention relates to apparatus for warming a tyre on a wheel to a temperature required for vehicle racing.

In competitive motor sports, it is well known that the temperature of tyres directly affects the adhesion of the tyres to a surface such for example as a racing track surface. The temperature of the tyres is either raised naturally during a race, or is achieved artificially by the use of thermally heated covers which are placed over the tyres and which are removed prior to actual racing.

If the tyres are left to heat naturally during a race, there will self-evidently be a period during the beginning of the race when the tyres are below the optimum temperature giving optimum surface adhesion. The use of the thermally heated covers enables the tyres to be heated prior to actual racing but the thermally heated covers are slow in terms of their speed of heating of the tyres, and they are also limited in terms of depth of penetration of heat into the tyres, this heating penetration being limited to surface contact conduction. Thus the use of thermally heated covers often leaves a tyre with an insufficient temperature, especially during race pit stops. This means that valuable time can be lost whilst the tyre heats naturally during race conditions.

It is an aim of the present invention to obviate or reduce the above mentioned problems.

Accordingly, in one non-limiting embodiment of the present invention there is provided apparatus for warming a tyre on a wheel to a temperature required for vehicle racing, which apparatus comprises a container in which the tyre is heated, mounting means which is positioned in the container and on which the wheel is mounted, generator means for generating electromagnetic energy of a frequency that heats the tyre, temperature indicator means for indicating the temperature of the tyre, and control means for controlling the operation of the apparatus such that the tyre is controllably heated to a temperature required for vehicle racing.

The apparatus of the present invention may be used on a wide variety of tyres for use in vehicle racing. Thus the tyres may be used on vehicles such for example as racing cars, motor cycles and go-karts. The apparatus of the present invention may provide a means of both speedily and evenly heating the tyre. The use of the chosen electromagnetic energy may enable speedy and deep heat penetration to take place. The apparatus of the invention is able to be such that it can be conveniently transported to a race site. The apparatus of the invention is also such that it can be easily and safely operated in order to heat the tyre on the wheel to the required temperature.

The apparatus of the invention may include rotator means for rotating the wheel in order to ensure even heating of the tyre in the container. The rotator means may be a turntable and a drive motor.

The apparatus may be one in which the container is of a size suitable for receiving only one wheel at a time. This ensures that the apparatus is able to be kept small for portability, and it also ensures that a tyre can quickly be inserted and removed from the apparatus. If desired, the container may be such that more than one wheel may be heated at a time.

Usually, the container will be constructed for quick opening in order to provide ease of access to the wheel to facilitate speedy insertion and removal of the wheel from the container as may be required during racing conditions. The container may thus comprise a body and a door which allows full access to the inside of the body.

Usually the container will be a circular container but containers of other shapes may be employed if desired.

The apparatus may be one in which the mounting means includes studs on which the wheel is placed. The mounting means may be any suitable and appropriate quick-locking and quick-release mounting means.

The wheel may be horizontally mounted in the container. Alternatively, the wheel may be vertically mounted in the container. The exact mounting position of the wheel will normally be chosen in order to facilitate ease of entry and removal of the wheel into the container.

The generator means may be for generating microwave energy as the electromagnetic energy. The microwave energy may be such that it meets one of four permissible industrial scientific and medical frequency bands for microwave heating. The microwave energy may be at a microwave frequency power of 2450 MHz. The microwave energy may be generated from generator means in the form of a conventional magnetron valve and wave guide assembly, or from a solid-state microwave coupling power generation electronic component arrangement.

The apparatus may alternatively be one in which the generator means is for generating radio frequency energy as the electromagnetic energy. The radio frequency energy employed may meet one of the three permissible industrial scientific and medical frequency bands for dielectric heating. Preferably the radio frequency power is of 13.56 Mhz. This radio frequency energy may be generated using solid state power generating electronic components.

Any suitable and appropriate temperature indicator means may be employed for indicating the temperature of the tyre. Thus, for example, various methods of remote temperature sensing of the tyre may be employed. Preferably the remote temperature sensing of the tyre utilises infrared sensing, allowing overall heating to be determined on previously established compound surface temperature requirements, based on the material's dielectric loss tangent and electrical conductivity determination.

The apparatus of the invention may be such that metal components form an active part of the apparatus. The apparatus of the present invention may be able to accommodate the use of metal structures, such as the wheel hub, as either an extension of the microwave cavity or as part of the radio frequency applicator. It can also be used for specific energy shielding purposes, especially where tyres having compounds of different dielectric properties and electrical conductivity are envisaged.

The apparatus of the invention is preferably constructed to be easily portable. Thus the apparatus can be used to safely generate and contain high frequency heating energy at a track side, using conveniently placed static or mobile electrical supplies, of either AC or DC electrical voltage supply. The AC voltage supply may be compatible with the specific voltage and frequency at a particular race venue, or it may be achieved through a separately mobile generator. The DC supply may be via a typical motor sport battery power pack system.

The apparatus of the present invention may use electromagnetic compatible suppression techniques. The electromagnetic energy distribution within the apparatus of the invention can be achieved by static means as an alternative to the above mentioned rotator means for rotating the wheel.

The apparatus of the present invention can be arranged to operate easily in pit lanes and at race track starting grids.

In a first further embodiment of the invention, the apparatus for warming the tyre may be suitable for the incorporation of supplementary thermal heating, such for example as can be achieved by radiation, conduction and convection means. One example of such supplementary thermal heating is the use of high frequency susceptor heating techniques. Susceptance and magnetic susceptability may both be employed. The use of high frequency susceptor heating techniques may be especially advantageous where using ferromagnetic (H plane) materials that can be adhered to a metal substrate to heat the wheel hub, and where temperature control is achieved by “Curie Point” (Curie Temperature) determination during the tyre warming process. The susceptor device may typically be incorporated within the wheel mounting means to transmit heat to the metal wheel hub, combining high frequency energy and high frequency generated thermally controlled heating within the tyre warming process.

In a second further embodiment of the invention, the apparatus for warming the tyre may be incorporated into the race vehicle construction. A high frequency generator may be fitted on-board the vehicle, using the vehicle's bodywork and electromagnetic field control techniques as the appropriate frequency into the matched tyre load, to safely control electromagnetic emissions. The high frequency energy may be applied to individual wheels in-situ as required. On-board telemetry radio feedback systems may be used to operate and control the vehicle tyre warming requirements during a race event. The racing vehicle's own electrical supply may provide the means for generating the high frequency energy.

Embodiments of the invention will now be described solely by way of example and with reference to the accompanying drawings in which:

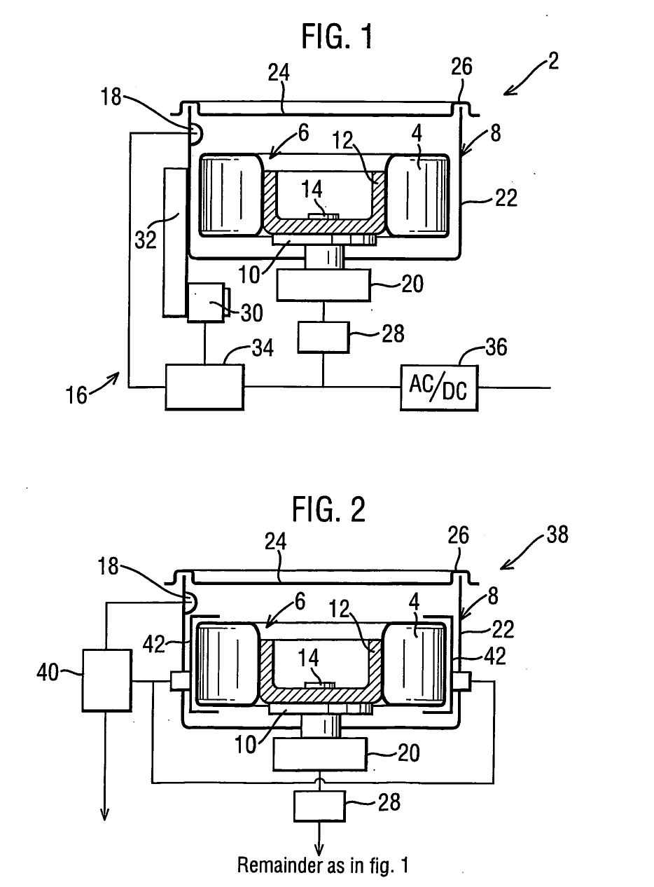

FIG. 1 shows first apparatus for warming a tyre on a wheel to the temperature required for vehicle racing;

FIG. 2 shows second apparatus for warming a tyre on a wheel to a temperature required for vehicle racing;

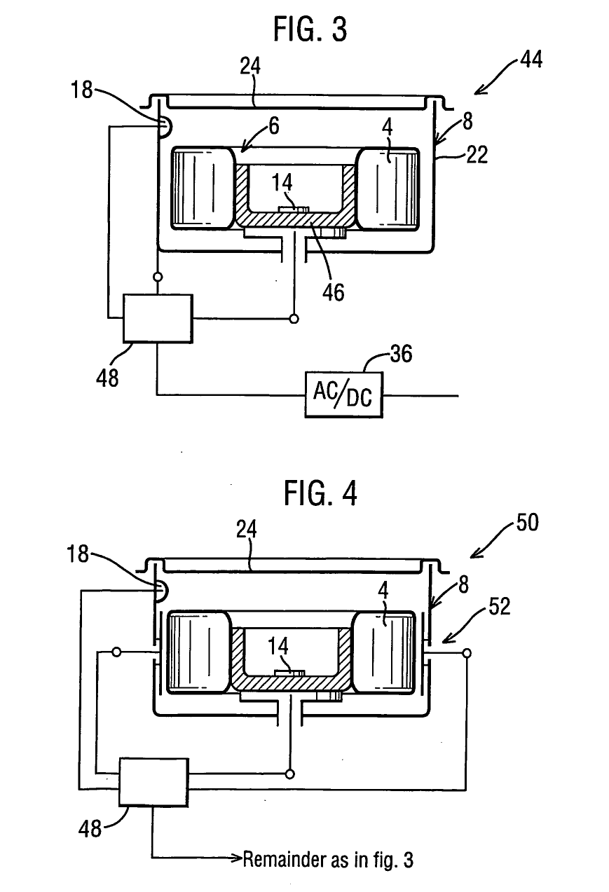

FIG. 3 shows third apparatus for warming a tyre on a wheel to a temperature required for vehicle racing;

FIG. 4 shows fourth apparatus for warming a tyre on a wheel to a temperature required for vehicle racing;

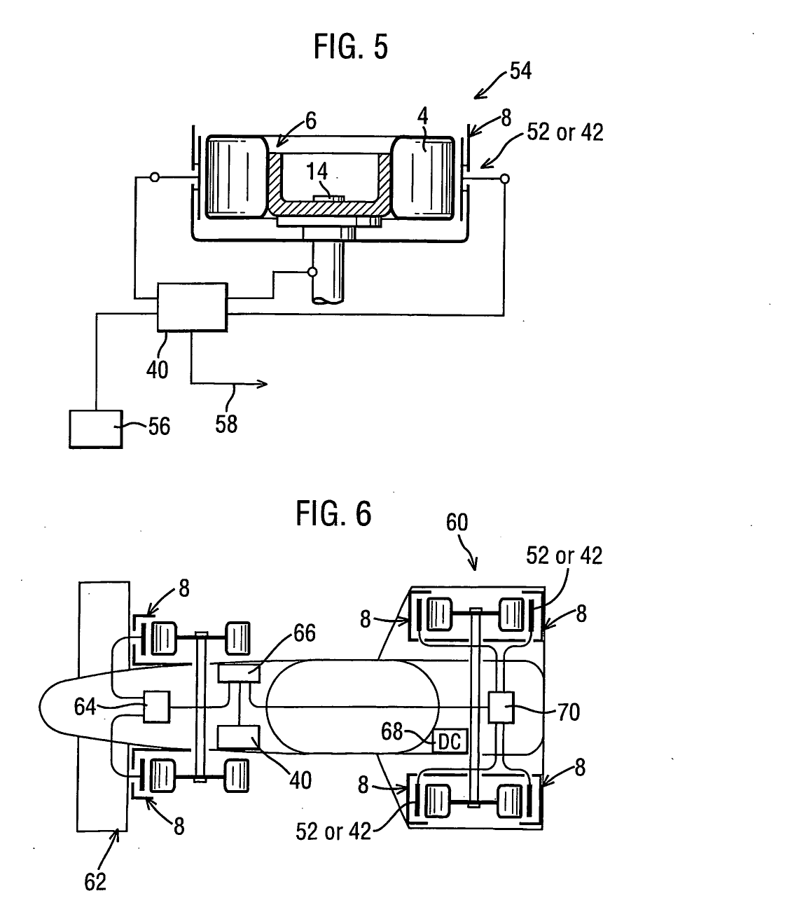

FIG. 5 shows fifth apparatus for warming a tyre on a wheel to a temperature required for vehicle racing; and

FIG. 6 shows sixth apparatus for warming a tyre on a wheel to a temperature required for vehicle racing;

Referring now to FIG. 1, there is shown apparatus 2 for warming a tyre 4 on a wheel 6. The tyre 4 is able to be warmed to a temperature required for vehicle racing. The apparatus 2 comprises a container 8 in which the tyre 4 is heated. The apparatus 2 also comprises mounting means 10 which is positioned in the container as shown and on which the wheel 6 is mounted. More specifically, the wheel 6 comprises a hub 12 and this hub 12 is mounted on an upstanding stud 14 forming part of the mounting means 10.

The apparatus 2 includes generator means 16 for generating electromagnetic energy of a frequency that heats the tyre 4. Temperature indicator means 18 are provided for indicating the temperature of the tyre 4. Control means (not shown) are provided for controlling the operation of the apparatus 2 such that the tyre 4 is controllably warmed to a temperature required for vehicle racing.

The apparatus 2 includes rotator means 20 for rotating the wheel 6 in order to ensure even heating of the tyre 4 in the container 8.

The container 8 is of a size suitable for receiving only one wheel 6 at a time. The container 8 is constructed for quick opening in order to provide easy access to the wheel 6 to facilitate speedy insertion and removal of the wheel 6 from the container 8 as may be required during racing conditions. It will be seen that the container 8 comprises a body 22 and a door 24. The door 24 allows full access to the inside of the body 2. The door 24 also includes a choke arrangement 26.

As can be seen from FIG. 1, the wheel 6 is horizontally mounted in the container 8. The rotator means 20 comprises a turntable and drive motor. The control means includes a drive motor speed control device 28.

The temperature indicator means 18 is a temperature sensor positioned inside the container 8. More than one of the temperature sensors may be employed if desired.

The generator means 16 comprises a magnetron 30 and a wave guide 32. The generator means 16 also comprises a microwave power supply unit 34 which is powered by an AC or DC supply 36.

When the container 8 is closed, the wheel 6 is able to be rotated via the mounting means 10 and the rotator means 20. The application of high frequency energy warms the tyre until the tyre reaches a predetermined temperature. At the predetermined temperature, the generator means 16 can either be switched off, or it can be controlled to emit a lower level of the electromagnetic energy for the maintenance of the predetermined temperature.

Referring now to FIG. 2, there is shown alternative apparatus 38 to that shown in FIG. 1. The lower part of the apparatus 38 is the same as the lower part of the apparatus 2, as indicated in FIG. 2.

In FIG. 2, similar parts as in FIG. 1 have been given the same reference numerals for ease of comparison and understanding. In FIG. 2, the magnetron 30 and the wave guide 32 used in FIG. 1 have been replaced by microwave generating solid state components in a high frequency power supply unit 40. Also, a feed system comprising tuning stubs and microwave antenna arrays 42 are positioned within the container 8.

FIG. 3 shows apparatus 44 in which similar parts as in previous Figures have again been given the same reference numerals. In FIG. 3, the apparatus 44 is such that the dimensions of the container 8 are less frequency wavelength dependent. This has allowed the use of a radio frequency electrode or electrodes 46 to be placed directly adjacent the surface of the tyre 4. The metal hub 12 or a separately independent structure may be used as the radio frequency electrode or electrodes 46. A radio frequency power supply matching and control unit 48 is employed.

FIG. 4 shows apparatus 50 which is like the apparatus 44 shown in FIG. 3 except that the radio frequency electrode 46 which was the hub in FIG. 3 is now radio frequency electrodes 52, which may be either separate plates or a circular applicator.

In FIGS. 5 and 6, similar parts as in previous Figures have been given the same reference numerals for ease of comparison and understanding.

FIG. 5 shows apparatus 54 which may use microwave antenna arrays 42 or a radio frequency electrode 52. Also employed in the apparatus 54 shown in FIG. 5 is container bodywork 8, and a high frequency power supply 40. An on-board radio telemetry device 56 is connected to the high frequency power supply 40. Also connected via a line 58 is an on-board DC electrical supply.

FIG. 6 shows apparatus 60 utilising an entire racing vehicle 62. There is a front wheel high frequency connection 64 using co-axial cables as shown. There is also a telemetry control system 66, an electrical supply 68 and a rear wheel high frequency connection 70 using co-axial cables. The power supply 40 may be any suitable and appropriate power supply.

It is to be appreciated that the embodiments of the invention described above with reference to the accompanying drawings have been given by way of example only and that modifications may be effected.

1. Apparatus for warming a tyre on a wheel to a temperature required for vehicle racing, which apparatus comprises a container in which the tyre is heated, mounting means which is positioned in the container and on which the wheel is mounted, generator means for generating electromagnetic energy of a frequency that heats the tyre, temperature indicator means for indicating the temperature of the tyre, and control means for controlling the operation of the apparatus such that the tyre is controllably heated to a temperature required for vehicle racing.

2. Apparatus according to claim 1 and including rotator means for rotating the wheel in order to ensure even heating of the tyre in the container.

3. Apparatus to claim 1 in which the container is of a size suitable for receiving only one wheel at a time.

4. Apparatus according to claim 1 in which the container is constructed for quick opening in order to provide ease of access to the wheel to facilitate speedy insertion and removal of the wheel from the container as may be required during racing conditions.

5. Apparatus according to claim 4 in which the container comprises a body and a door which allows full access to the inside of the body.

6. Apparatus according to claim 1 in which the container is a circular container.

7. Apparatus according to claim 1 in which the mounting means includes studs on which the wheel is placed.

8. Apparatus according to claim 1 in which the wheel is horizontally mounted in the container.

9. Apparatus according to claim 1 in which the wheel is vertically mounted in the container.

10. Apparatus according to claim 1 in which the generator means is for generating microwave energy as the electromagnetic energy.

11. Apparatus according to claim 1 in which the generator means is for generating radio frequency energy as the electromagnetic energy.

12. Apparatus according to claim 1 and in which metal components form an active part of the apparatus.

13. Apparatus according to claim 1 and which is constructed to be portable.
